(19) United States
(12) Patent Application Publication
(10) Pub. No.: US 2021/0125004 A1
(43) Pub. Date: Apr. 29, 2021

(54) AUTOMATED LABELING OF DATA WITH USER VALIDATION

(71) Applicant: Element AI Inc., Montreal (CA)

(72) Inventor: Eric ROBERT, Montreal (CA)

(73) Assignee: Element AI Inc., Montreal, QC (CA)

(21) Appl. No.: 16/972,071

(22) PCT Filed: Jun. 7, 2019
(86) PCT No.: PCT/CA2019/050800

§ 371 Date: Dec. 4, 2020

Related U.S. Application Data
(60) Provisional application No. 62/681,997, filed on Jun. 7, 2018.

(51) Int. Cl. G06K 9/62; G06K 9/00; G06N 3/04; G06N 3/08

(52) U.S. Cl. CPC G06K 9/6263; G06K 9/6272; G06N 3/08; G06K 9/00463; G06N 3/04; G06K 9/6259

(57) ABSTRACT

Systems and methods for automatic labeling of data with user validation and/or correction of the labels. In one implementation, unlabeled images are received at an execution module and changes are made to the unlabeled images based on the execution module's training. The resulting labeled images are then sent to a user for validation of the changes. The feedback from the user is then used in further training the execution module to further refine its behaviour when applying changes to unlabeled images. To train the execution module, training data sets of images with changes manually applied by users are used. The execution module thus learns to apply the changes to unlabeled images. The feedback from the user works to improve the resulting labeled images from the execution module.

### TECHNICAL FIELD

The present invention relates to labeled and unlabeled data sets. More specifically, the present invention relates to systems and methods for converting unlabeled data sets into labeled data sets in a semi-automated fashion.

### BACKGROUND

The field of machine learning is a burgeoning one. Daily, more and more uses for machine learning are being discovered. Unfortunately, to properly use machine learning, data sets suitable for training are required to ensure that systems accurately and properly accomplish their tasks. As an example, for systems that recognize cars within images, training data sets of labeled images containing cars are needed. Similarly, to train systems that, for example, track the number of trucks crossing a border, data sets of labeled images containing trucks are required.

As is known in the field, these labeled images are used so that, by exposing systems to multiple images of the same item in varying contexts, the systems can learn how to recognize that item. However, as is also known in the field, obtaining labeled images which can be used for training machine learning systems is not only difficult, it can also be quite expensive. In many instances, such labeled images are manually labeled, i.e. labels are assigned to each image by a person. Since data sets can sometimes include thousands of images, manually labeling these data sets can be a very time consuming task.

It should be clear that labeling video frames also runs into the same issues. As an example, a 15-minute video running at 24 frames per second will have 21,600 frames. If each frame is to be labeled so that the video can be used as a training data set, manually labeling the 21,600 frames will take hours if not days.

It should also be clear that other tasks relating to the creation of training data sets are also subject to the same issues. As an example, if a machine learning system requires images that have items to be recognized as being bounded by bounding boxes, then creating that training data set of images will require a person to manually place bounding boxes within each of multiple images. If thousands of images will require such bounding boxes to result in a suitable training data set, this will, of course, require hundreds of man-hours of work.

From the above, there is therefore a need for systems and methods that address the issues noted above. Preferably, such systems and methods would work to ensure the accuracy and proper labeling of images for use training data sets.

### SUMMARY

The present invention relates to systems and methods for automatic labeling of data with user validation and/or correction of the labels. In one implementation, unlabeled images are received at an execution module and changes are made to the unlabeled images based on the execution module's training. At least some of the resulting labeled images are then sent to a user for validation of the changes. The feedback from the user is then used in further training the execution module to further refine its behaviour when applying changes to unlabeled images. To train the execution module, training data sets of images with changes manually applied by users are used. The execution module thus learns to apply the changes to unlabeled images. The feedback from the user works to improve the resulting labeled images from the execution module. A similar process can be used for text and other types of data that have been machine labeled.

In a first aspect, the present invention provides a method for converting unlabeled data into labeled data, the method comprising:
a) receiving said unlabeled data;
b) passing said unlabeled data through an execution module that applies a change to said unlabeled data to result in said labeled data;
c) sending said labeled data to a user for validation;
d) receiving user feedback regarding said change;
e) using said user feedback to train said execution module.

In a second aspect, the present invention provides a system for labeling an unlabeled data set, the system comprising:
an execution module for receiving said unlabeled data set and for applying a change to said unlabeled data set to result in a labeled data set;
a validation module for sending said labeled data set to a user for validation and for receiving feedback from said user;
wherein said feedback is used for further training said execution module.

In a third aspect, the present invention provides computer readable media having encoded thereon computer readable and computer executable instruction that, when executed, implements a method for converting unlabeled data into labeled data, the method comprising:
a) receiving said unlabeled data;
b) passing said unlabeled data through an execution module that applies a change to said unlabeled data to result in said labeled data;
c) sending said labeled data to a user for validation;
d) receiving user feedback regarding said change;
e) using said user feedback to train said execution module.

### BRIEF DESCRIPTION OF THE DRAWINGS

The embodiments of the present invention will now be described by reference to the following figures, in which identical reference numerals in different figures indicate identical elements and in which:

FIG. 1 is a block diagram of a system according to one aspect of the invention;

FIG. 2A is a variant of the system illustrated in FIG. 1;

FIG. 2B is a video frame that has been labeled by a system according to one aspect of the invention;

FIG. 2C is a form where bounding boxes have been placed in sections containing user-entered information;

FIG. 2D is an image that has been segmented such that pixels corresponding to human hands have been labeled by using different coloring;

FIG. 3 is another variant of the system illustrated in FIG. 1; and

FIG. 4 is a flowchart detailing the steps in a method according to another aspect of the present invention.

### DETAILED DESCRIPTION

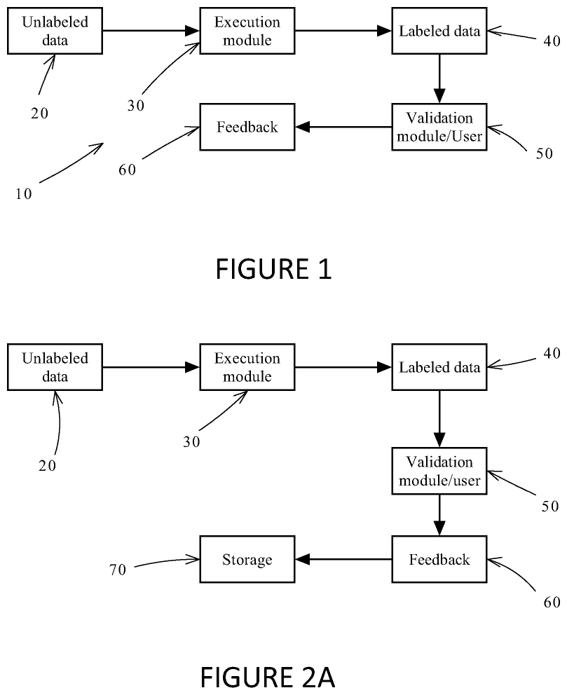

Referring to FIG. 1, a block diagram of a system according to one aspect of the invention is illustrated. In this implementation, the system is configured to accept, label, and validate an unlabeled data set image. The system 10 has an unlabeled data set image 20, an execution module 30, and a resulting labeled data set image 40. The unlabeled data set image is received by the execution module 30 and a change is applied to the unlabeled data set image 20 by the execution module 30. The resulting labeled data set image 40 is then sent to a user 50 for validation by way of a validation module. The user 50 confirms or edits the change applied by the execution module 30 to the unlabeled data image 20. The user feedback 60 can then be used to further train the execution module 30 in applying better changes to the unlabeled data set images.

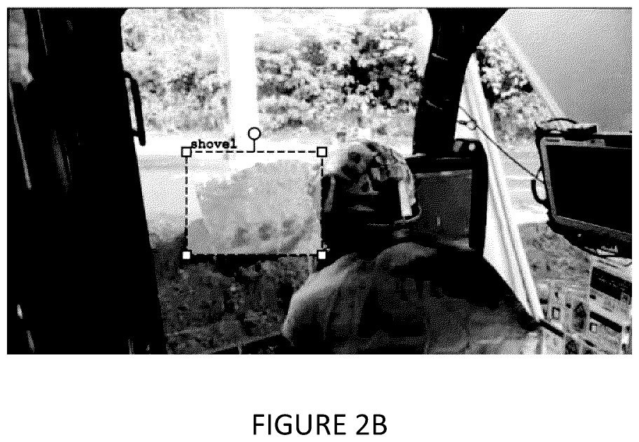

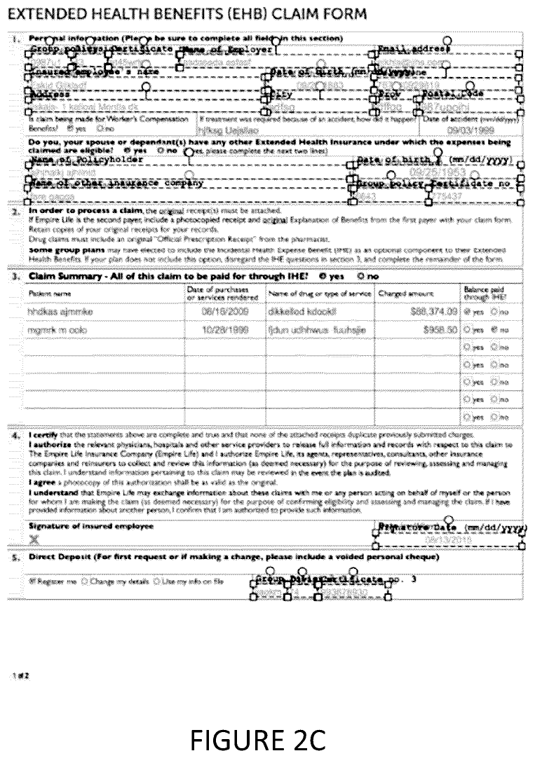

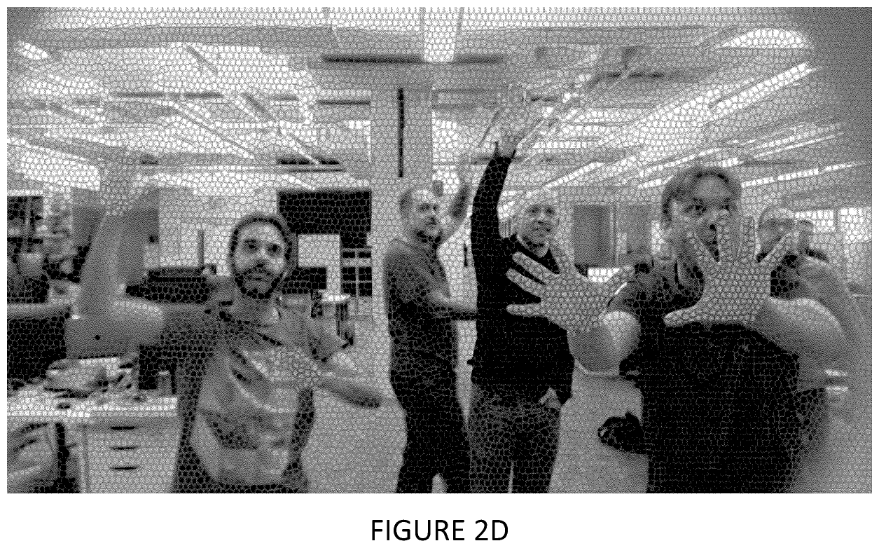

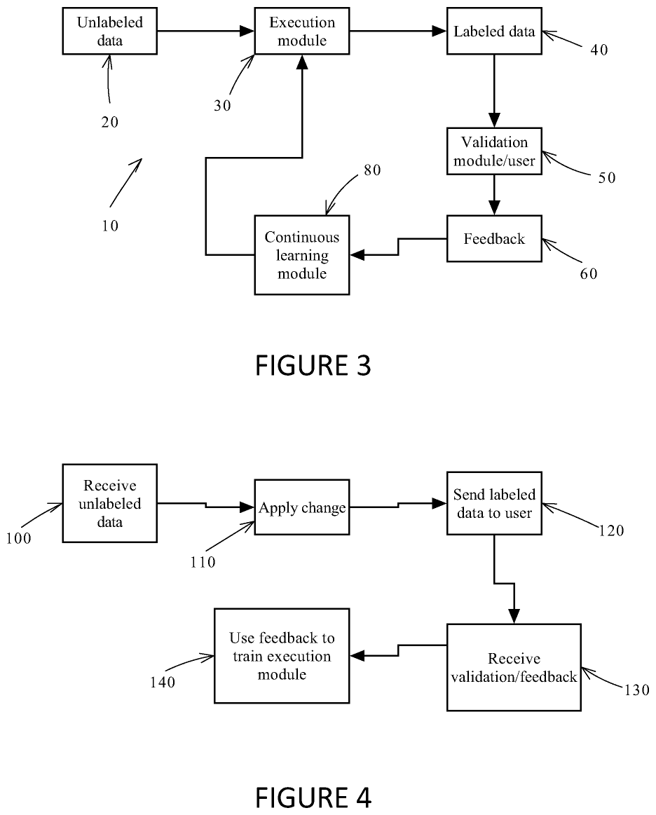

Referring to FIG. 2, the feedback 60 is stored in a storage module 70 and is used in later training the behaviour of the execution module 30. Alternatively, in FIG. 3, the feedback 60 is sent to a continuous learning module 80 that adjusts the behaviour of the execution module 30 based on the feedback 60. In FIG. 3, the continuous learning module 80 continuously learns and adjusts the behaviour of how and what the execution module 30 applies the change to the unlabeled data 20.

As can be imagined, once user 50 approves or validates the change applied to the unlabeled data image 20 to result in the labeled data image 40, this labeled data image 40 can be used in a training data set. However, should the user 50 disapprove and/or edit the change applied by the execution module, this disapproval and/or the edit is used to further train the execution module 30. It should be clear that the further training of the execution module 30 may be continuous (as in the configuration illustrated in FIG. 3) or it may be executed at different times, with collected data (i.e. user feedback) being applied as training data for the execution module (as in the configuration in FIG. 2).

It should be clear that, while the above description is specific to an unlabeled data set image, a similar system can be used to label and validate text and other types of unlabeled data.

In one implementation, the execution module 30 includes a convolutional neural network (CNN) that has been trained using manually labeled training data sets. These training data sets provide the CNN with examples of desired end results, e.g. labeled data set images or simply labeled data sets. In one example, the labeled data set images were video frames from a video clip of a backhoe. The change desired in the unlabeled data set images was the placement of a bounding box around the bucket of the backhoe (see FIG. 2A). As can be seen in FIG. 2A, the system has placed a bounding box around the shovel of the backhoe in the frame from a video clip. In another example, the CNN is trained to detect the presence or absence of a particular item or a particular indicia (e.g. a logo or a trademark) in the unlabeled images. The training data set used is therefore a manually labeled data set where the images are each tagged as having the item within the image or as not having the item within the image. The execution module, once trained, would therefore apply a label or apply a tag to each image as to whether the image contains the item or not.

It should be clear that, once the execution module has been trained, unlabeled images can be received by the execution module and the desired change to each unlabeled image can be applied by the execution module. Once this change has been applied, the resulting labeled image is sent to a user for validation. Once validated, the labeled image can be stored and used as part of a training data set. However, if the labeled data image is not suitable (e.g. the bounding box does not contain the desired item or the item to be located in the image is not within the image, but the label indicates that the item is present), the user can edit the change. Thus, the user can, for example, change the scope of the bounding box that has been applied to the image so that the item that is to be bounded by the bounding box is within the box. In another example, the user can change the label or tag applied to the image to indicate the absence of the desired item from the image.

Once the user has edited the change applied to the labeled data set image, the edited data set image is then used as feedback. As noted above, this feedback can be used as part of a new training data set for use in further training the execution module.

It should be noted that the system of the present invention may provide advantage when the validation required from the user does not require much effort from the user. As an example, for a labeled data set where the change from the unlabeled data set is simply the addition of a bounding box around a specific item in the image, a user can easily validate/approve hundreds of properly labeled images. Even if a small subset of the labeled images are improperly labeled (i.e. the bounding box does not include the item within its boundaries), the user's edited change (that of adjusting the scope of the bounding box) would not be an onerous task for the user. Similarly, if the change desired in the labeled image is the assignment of a specific label indicating the presence or absence of an item in the image, this would, again, not be an onerous task for the user to change an improperly assigned label, especially since there are only two labels which could be assigned (e.g. “present” or “absent” to indicate the presence or absence of the item in the image). For most labeling tasks where the change required to convert an unlabeled data set image to a labeled data set image is binary in nature (e.g. applying a label of “present” or “absent” regarding the presence or absence of a specific item in the image), then the system of the present invention would provide great advantage as a user would simply need to change an assigned label from one possible value to the only other possible value. Other tasks might require more effort from the user, such as correcting an OCR derived label or recognizing and correcting letters or numbers. In FIG. 2B, the task for the system was to place bounding boxes around areas in a claim form that had user entered data. As can be seen from FIG. 2B, the areas with bounding boxes included the sections containing personal information (e.g. name, address, data of birth, email address, and policy number). Of course, validating quite a lot of labeled data points in one image may take some time as the user may need to pay a lot more attention. A task that merely requires that the user determine if a single box in the labeled image encompasses a specific item would not require a lot of cognitive effort as correcting an incorrect box merely requires dragging the limits of the box to expand or constrain the area encompassed by the box.

Experiments have also shown that the system of the present invention also provides advantage when the unlabeled data set comprises frames from a video that tracks the movement of an item. For this example, where the change desired is to locate the item being tracked in the video, the system can either locate the item in the video frame or place a bounding box encompassing the item being tracked. A user validating the resulting labeled data set merely has to move the bounding box, change the limits of the bounding box, or tag/click the item in the image. Again, since this correcting task is not cognitively onerous, a user can quickly validate/edit large volumes of labeled data set images in a short amount of time.

It should be clear that the system of the invention may be used for various automated labeling tasks that can be validated by a user. The validation may be quick and may not take a lot of cognitive effort on the part of the user (e.g. determining if a bounding box placed on the image properly covers the item or feature being highlighted) or it might take a fair amount of effort on the user's part (e.g. confirming that an OCR transcription of a line of text is correct). In another example, the system may be used to segment an image so that each relevant pixel is properly labeled (e.g. colored differently from the rest of the image). For this example, the image may be segmented, and specific pixels can be highlighted. FIG. 2C shows one such example. In this example, the system was tasked with segmenting the image and labeling or highlighting the pixels that covered a human's hands. As can be seen from the figure, the pixels corresponding to human hands have been labeled by coloring them green. Once the relevant pixels have been labeled, the resulting image can be validated by a user. In another example, a text box or text in an image may form the input to the system and the labeling task for the system may involve recognizing and transcribing the text in the text box or image. The validation step for this example would be for the user to confirm that the transcription and/or recognizing the text is correct.

It should also be clear that the various aspects of the invention encompass different variants. As an example, while the figures and the description above describe a “bounding box”, the “box” that is used to delineate features in the image may not be box-shaped or rectangular/square shaped. Other shapes and delineation methods (e.g. point, line, polygon) are also possible and are covered by the present invention. As well, other configurations of such boxes and other configurations of the system are also covered by the present invention.

In one variant of the invention, the feedback used in training the execution module may take a number of forms. In a first variant, all the validated images and all the corrected labeled images are used in training the execution module. In this variant, all the correctly applied changed images are used as feedback. Thus, if the execution module correctly applied the desired change to the unlabeled images, these resulting labeled images are used as feedback. As well, if the execution module incorrectly applied the change (e.g. the desired item in the image was not within the applied bounding box), the user corrected, or user edited labeled image with the change correctly applied is used as feedback as well. In this variant, the correctly applied changes would operate as reinforcement of the execution module's correct actions while the user corrected labeled images should operate as being corrective of the execution module's incorrect actions.

In another variant to the above, only the user corrected images are used as feedback. For this variant, the labeled images to which the execution module has correctly applied the change would be passed on to be used as training data set images and would not form part of the feedback. This means that only the user edited or user corrected labeled images would be included in the feedback.

In a further variant of the system, the user validation may take the form of only approving or not approving the labeled data set images from the execution module. In this variant, the disapproved data set images (i.e. the images where the change was incorrectly applied) would be discarded. Conversely, the approved labeled data set images could be used as part of the feedback and could be used as part of a new training set for the execution module. Such a variant would greatly speed up the validation process as the user would not be required to edit/correct the incorrectly applied change to the labeled data image.

Referring to FIG. 4, a flowchart detailing the steps in a method according to another aspect of the present invention is illustrated. The method begins at step 100, that of receiving the unlabeled data set. This unlabeled data set is then sent to an execution module where a change is applied to the unlabeled data set (step 110). As noted above, this change is based on the data sets that the execution module has been trained with. Once this change has been applied to the unlabeled data set, the resulting labeled data set is sent to a user (step 120) for validation. Step 130 is that of receiving the user's feedback regarding the application of the change to the labeled data set. As noted above, the feedback can include the user's validation (i.e. approval) of the change applied or it can include the user's edits/correction of the change applied. This feedback can then be used to further train the execution module (step 140).

To arrive at the training set, as noted above, labels or boxes are applied to images in a data set by an individual or a collection of individuals. To manually label or apply a change to a data set, the changes may be manually applied on a per image basis using one or more individuals. Thus, if 2 or more labels are to be applied to a dataset of images, each individual applying a change would apply those two or more labels to each image. Alternatively, the manual labelling of the data set may be accomplished in what may be termed “batch mode”. Such a batch mode labelling involves an individual applying the same label or performing the same single change to images in a data set. Then, if there are 2 or 3 labels to be applied, the same or a different individual would apply another specific change to the multiple images in that data set and the process would repeat. Thus, if a data set requires that a car, a street sign, and a signal light to be identified in each image, the individual applying the label would first label or box off the car in all the images. Then, in the second pass through, the street sign in all the images would be identified/boxed off. Then, in the final pass through, the signal light would be labelled or identified in the images. This would be in contrast to a method where the individual applying the labels would identify, at the same time, the car, street sign, and signal light in each image.

It should be clear that the various aspects of the present invention may be implemented as software modules in an overall software system. As such, the present invention may thus take the form of computer executable instructions that, when executed, implements various software modules with predefined functions.

The embodiments of the invention may be executed by a computer processor or similar device programmed in the manner of method steps, or may be executed by an electronic system which is provided with means for executing these steps. Similarly, an electronic memory means such as computer diskettes, CD-ROMs, Random Access Memory (RAM), Read Only Memory (ROM) or similar computer software storage media known in the art, may be programmed to execute such method steps. As well, electronic signals representing these method steps may also be transmitted via a communication network.

Embodiments of the invention may be implemented in any conventional computer programming language. For example, preferred embodiments may be implemented in a procedural programming language (e.g. “C”) or an object-oriented language (e.g.“C++”, “java”, “PHP”, “PYTHON” or “C#”). Alternative embodiments of the invention may be implemented as pre-programmed hardware elements, other related components, or as a combination of hardware and software components.

Embodiments can be implemented as a computer program product for use with a computer system. Such implementations may include a series of computer instructions fixed either on a tangible medium, such as a computer readable medium (e.g., a diskette, CD-ROM, ROM, or fixed disk) or transmittable to a computer system, via a modem or other interface device, such as a communications adapter connected to a network over a medium. The medium may be either a tangible medium (e.g., optical or electrical communications lines) or a medium implemented with wireless techniques (e.g., microwave, infrared or other transmission techniques). The series of computer instructions embodies all or part of the functionality previously described herein. Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (e.g., shrink-wrapped software), preloaded with a computer system (e.g., on system ROM or fixed disk), or distributed from a server over a network (e.g., the Internet or World Wide Web). Of course, some embodiments of the invention may be implemented as a combination of both software (e.g., a computer program product) and hardware. Still other embodiments of the invention may be implemented as entirely hardware, or entirely software (e.g., a computer program product).

A person understanding this invention may now conceive of alternative structures and embodiments or variations of the above all of which are intended to fall within the scope of the invention as defined in the claims that follow.

What is claimed is:

1. A method for converting unlabeled data into labeled data, the method comprising:
a) receiving said unlabeled data;
b) passing said unlabeled data through an execution module that applies a change to said unlabeled data to result in said labeled data;
c) sending said labeled data to a user for validation;
d) receiving user feedback regarding said change;
e) using said user feedback to train said execution module.

2. The method according to claim 1, wherein said execution module comprises a neural network.

3. The method according to claim 2, wherein said execution module comprises a convolutional neural network.

4. The method according to claim 1, wherein said user feedback comprises corrections to said change.

5. The method according to claim 1, wherein said unlabeled data comprises an unlabeled data image.

6. The method according to claim 5, wherein said change comprises at least one of:
adding a bounding box to a portion of said unlabeled data image;
locating an item in said unlabeled data image;
identifying a presence or an absence of a specific item in said unlabeled data image and applying a label/tag associated with said unlabeled data image, said label/tag being based on whether said specific item is present or absent in said unlabeled data image;
placing a border around an item located in said unlabeled data image; and
determining if indicia is present in said unlabeled data image and applying a label to said unlabeled data image, said label being related to said indicia.

7. The method according to claim 1, wherein said feedback used in step e) comprises corrected labeled data where said change has been corrected by said user.

8. The method according to claim 1, wherein said feedback used in step e) comprises said labeled data to which said execution module has correctly applied said change.

9. The method according to claim 1, wherein said feedback used in step e) consists only of corrected labeled data where said change has been corrected by said user.

10. The method according to claim 5, wherein said unlabeled data image is a video frame.

11. The method according to claim 1, wherein said feedback consists of an approval or a rejection of said changes.

12. A system for labeling an unlabeled data set, the system comprising:
an execution module for receiving said unlabeled data set and for applying a change to said unlabeled data set to result in a labeled data set;
a validation module for sending said labeled data set to a user for validation and for receiving feedback from said user;
wherein said feedback is used for further training said execution module.

13. The system according to claim 12, further comprising a storage module for storing said feedback received from said user.

14. The system according to claim 12, further comprising a continuous learning unit for receiving said feedback from said validation module and for adjusting a behaviour of said execution unit based on said feedback.

15. The system according to claim 12, wherein said execution unit comprises a neural network.

16. The system according to claim 15, wherein said execution unit comprises a convolutional neural network.

17. The system according to claim 12, wherein said unlabeled data set comprises unlabeled data set images.

18. Computer readable media having encoded thereon computer readable and computer executable instruction that, when executed, implements a method for converting unlabeled data into labeled data, the method comprising:
a) receiving said unlabeled data;
b) passing said unlabeled data through an execution module that applies a change to said unlabeled data to result in said labeled data;
c) sending said labeled data to a user for validation;
d) receiving user feedback regarding said change;
e) using said user feedback to train said execution module.
